(19) United States
(12) Patent Application Publication
(10) Pub. No.: US 2005/0115748 A1
(43) Pub. Date: Jun. 2, 2005

(54) All-wheel drive electric vehicle

(76) Inventor: Theodore D. Lanier, Bronx, NY (US)

Correspondence Address: Steven Horowitz;Counselor At Law, Suite 700, 295 Madison Avenue, New York, NY, 10017, US

(21) Appl. No.: 10/724,241

(22) Filed: Nov. 28, 2003

(51) Int. Cl. B60K 1/00

(52) U.S. Cl. 180/65.1

(57) ABSTRACT

A four wheel drive electric vehicle that runs on a road and on an electrified track comprising a motor, a battery pack, an accelerator, an alternator, an auxiliary generator capable, once the electric vehicle reaches approximately 20 m.p.h., of charging the battery when the battery pack is off or, when the battery pack is on, of transmitting electricity to the motor for extra power, an electrical system, a pair of motorized legs with balled feet, each of the motorized legs capable of being lowered so as to make contact with the electrified track that supplies electric power to drive the electric motor when the battery pack is off and a cooling system for cooling the motor including a cooling tank that contains oil that is circulated through oil piping. A separate portable charger for charging the batteries at home or when the vehicle is not in use is included.

### BACKGROUND OF THE INVENTION

1. Field of the Invention

The field of this invention is electric vehicles, and more particularly, all-wheel drive electric vehicles.

2. Discussion of the Prior Art

Electric vehicles are well known. However, one problem with known electric vehicles is that they typically can be driven only on a road. Although roads are the main way in which vehicles traverse land, and they have obvious advantages, roads also have disadvantages if the main vehicles that would be using them for travel are electric vehicles such as electric cars. One such disadvantage is that the electric vehicles have to be charged on the road constantly. That requires constant stopping which uses up time and the construction of electric stations for charging. Electric tracks have been proposed but a network of electric tracks has not been laid and even if such a network is laid it is unlikely that it would replace all existing roads in the foreseeable future. Thus there is a need for an electric vehicle that can be used for driving both on ordinary roads and highways and also on a network of electric tracks. This way if a portion of the transportation network remained roads and highways while a portion of the transportation network were converted into electric tracks, there would be a vehicle that can negotiate both portions of the transportation network.

In addition, known electric vehicles are not constructed in a manner that would allow them to be used on electric tracks.

Another problem with electric vehicles is the cooling system. It is based on anti-freeze or a similar coolant. Anti-freeze is an acceptable coolant but there may be occasions where other materials are available and anti-freeze type coolants are not available. Thus is a need for motor cooling systems that utilize alternative coolants.

Still another problem with known electric vehicles is that they typically produce only a moderate amount of volts. This limits the acceleration capacity of the vehicles. It is well known that electric vehicles are not as capable of acceleration as gas-propelled vehicles and are poorer performers with regard to passing and hill climbing. Thus there is a need for maximizing the acceleration capability of electric vehicles.

The present invention solves these problems and provides other benefits as well.

### SUMMARY OF THE PRESENT INVENTION

A four wheel drive electric vehicle that runs on a road and on an electrified track comprises an electric drive motor, a battery pack, a foot powered accelerator connected to the electric drive motor that controls an amount of electricity that travels to the electric drive motor, an alternator, an auxiliary generator capable, once the electric vehicle reaches approximately twenty m.p.h., of charging the battery when the battery pack is off or, when the battery pack is on, of transmitting electricity to the motor for extra power, an electrical system for conveying electrical energy from the battery pack to the electric drive motor and for conveying electrical energy from the auxiliary generator to either the electric drive motor or the battery pack, the electrical system including a voltage regulator for regulating the voltage coming out of the auxiliary generator, a pair of motorized legs with balled feet, each of the motorized legs capable of being lowered so as to make contact with the electrified track that supplies electric power to drive the electric drive motor when the battery pack is off and a cooling system for cooling the motor including a cooling tank that contains oil that is circulated through oil piping. A separate portable charger for charging the batteries at home or when the vehicle is not in use is included. The vehicle also includes the usual essential elements such as a chassis including a driving wheel, two front wheels on opposite ends of a front axle, a front differential positioned on the front axle and a front drive shaft connected to the differential, two rear wheels on opposite ends of a rear axle, a rear differential positioned on the rear axle and a rear drive shaft connected to the differential, a transfer case for transmitting rotary motion to the front and rear drive shafts and a transmission connected to the electric drive motor

### IMPORTANT OBJECTS AND ADVANTAGES

The following important objects and advantages of the present invention are:
(1) to provide an electric vehicle that can be driven over an electric track;
(2) to provide an electric vehicle whose force is produced from the turning of each of the four wheels of the vehicle,
(3) to provide an electric vehicle whose electrical system can produce 120 volts of force to move the vehicle;
(4) to provide an electric vehicle that is suitable for being driven both on the road and highway and on an electric track;
(5) to provide an electric vehicle that has a cooling system for the motor that uses oil as the coolant;
(6) to provide an electric vehicle whose battery can be charged when the vehicle is not in use;
(7) to provide an electric vehicle whose battery can be charged while the driver is at home;
(8) to provide an electric vehicle that can draw on several different power sources including an electric track, a battery pack and an auxiliary generator;
(9) to provide an electric vehicle that can easily climb an upward incline such as a hill;
(10) to provide an electric vehicle that can easily pass another automobile on the highway;
(11) to provide an electric vehicle whose battery can be charged while the vehicle is being driven;
(12) to provide an electric vehicle that has two electric generators—the auxiliary generator that can provide auxiliary electricity to assist the battery and an alternator that can be used to run the accessory systems of the vehicle, such as the lights, air conditioning, etc.;
(13) to provide an electric vehicle with motorized legs so that with the push of a button the vehicle can be switched into a mode that draws electricity from an electric track and allows the vehicle to run on the electric track; and
(14) to provide an electric vehicle that can negotiate all parts of a transportation network, a portion of which is roads and highways and a portion of which is a network of electric tracks.

### BRIEF DESCRIPTION OF THE DRAWINGS

FIG. 1 is a flow diagram of the all-wheel electric vehicle of the present invention.

FIG. 2 is a side view of the cooling system of the all-wheel electric vehicle of the present invention.

FIG. 3 is a bottom view of the all-wheel electric vehicle of the present invention.

FIG. 4 is a front view of the all-wheel electric vehicle of the present invention with its motorized legs in a “down” position.

FIG. 5 is a side view of an alternative embodiment showing a rear wheel drive electric vehicle in accordance with the present invention with its motorized legs in a “down” position.

FIG. 6 is an electric wiring diagram for the all-wheel drive electric vehicle of the present invention.

### DETAILED DESCRIPTION OF THE PREFERRED EMBODIMENT

The apparatus of the present invention will now be illustrated by reference to the accompanying drawings. The electric vehicle of the present invention has been assigned reference numeral 100 Other elements have been assigned the reference numerals referred to below.

It is noted that the terms “electric motor” and “electric drive motor” is used herein to denote the vehicle's motor that causes the vehicle to move. Any other reference to a “motor” is to one or more motors that are designed merely to operate particular limited parts within the vehicle such as the motor for the fan, i.e. the fan motor, or the motors associated with the legs, i.e. the leg motors, as described in further detail below.

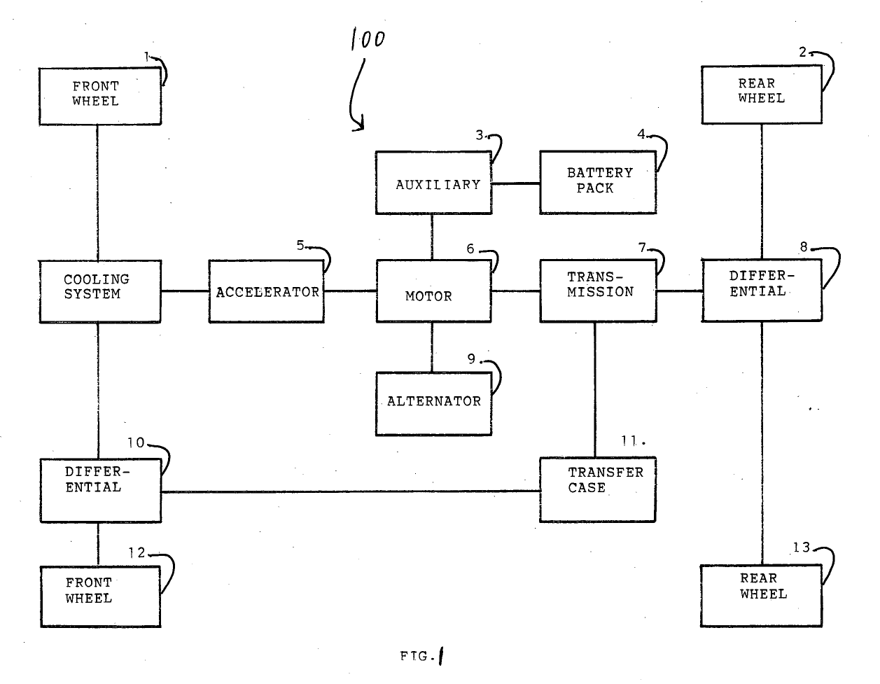

As seen from FIGS. 1-6, the electric vehicle of the present invention is an all-wheel drive electric vehicle that runs on a road and on an electrified track. Certain parts of the vehicle 100 are standard and well known. For example a chassis, a driving wheel and other well known parts of a standard automobile or other vehicle are included. There are two front wheels on opposite ends of a front axle, a differential positioned on the front axle and a front drive shaft connected to the differential and there are two rear wheels on opposite ends of a rear axle, a differential positioned on the rear axle and a rear drive shaft connected to the differential. A transfer case for transmitting rotary motion to the front and rear drive shafts.

The vehicle 100 includes an electric drive motor 33, a battery pack 48 with a battery switch 25 for turning the battery pack 48 on or off and a transmission connected to the electric drive motor. The vehicle 100 also includes a foot powered accelerator 80 connected to the electric drive motor that controls an amount of electricity that travels to the electric drive motor. Vehicle 100 also includes an alternator 9 for generating electric power to operate accessories in the electric vehicle, and an auxiliary generator 35. The auxiliary generator 35 is capable, once the electric vehicle attains a speed of approximately 20 m.p.h., of charging the battery pack when the battery pack has been turned off and of assisting the battery pack when the battery pack is turned on, by transmitting electricity to the electric drive motor for extra power, such as when climbing hills or passing vehicles

Vehicle 100 includes an electrical system for conveying electrical energy from the battery pack to the electric drive motor and for conveying electrical energy from the auxiliary generator 35 to the electric drive motor and the battery pack, the electrical system including a voltage regulator for regulating the voltage output of the auxiliary generator 35. Electricity flows from the auto battery to the starter switch and then to the accessory terminal and through the indicator light to the regulator. From there electricity flows to the alternator 9 and from the alternator 9 it flows to the auto battery to charge it. Electricity also flows from the regulator through diode to the auto battery. Accordingly, a double charging occurs from this process. In addition, when starter switch is turned on electricity flows from the accessory terminal to the battery pack switch 25 and then to the auxiliary switch 36 and finally to the voltage regulator 21 which controls the flow of electric power coming out of the auxiliary generator 35.

The above describes events when the motorized legs are in an up position and not in contact with electric track. Following this assumption further, when the battery switch is on it activates battery relay and permits electricity to flow from the battery pack 48 through circuit breaker, shunt and electric drive motor 33 and through the foot controlled accelerator 80. When the battery relay is turned off and the output from battery pack 48 is stopped, auxiliary generator 35 can then charge battery pack 48 provided voltage regulator is placed in an on position. Thus, auxiliary generator 35 drives electric motor 33 and aids battery pack 48 with back-up power for passing, climbing hills etc.

It is noted, however, that neither the alternator 9 nor the auxiliary generator 35 will send electricity to the vehicle's electrical system until the vehicle has attained a speed of approximately 20 miles per hour. This is only a crude approximation and the required speed may be somewhat higher or somewhat lower.

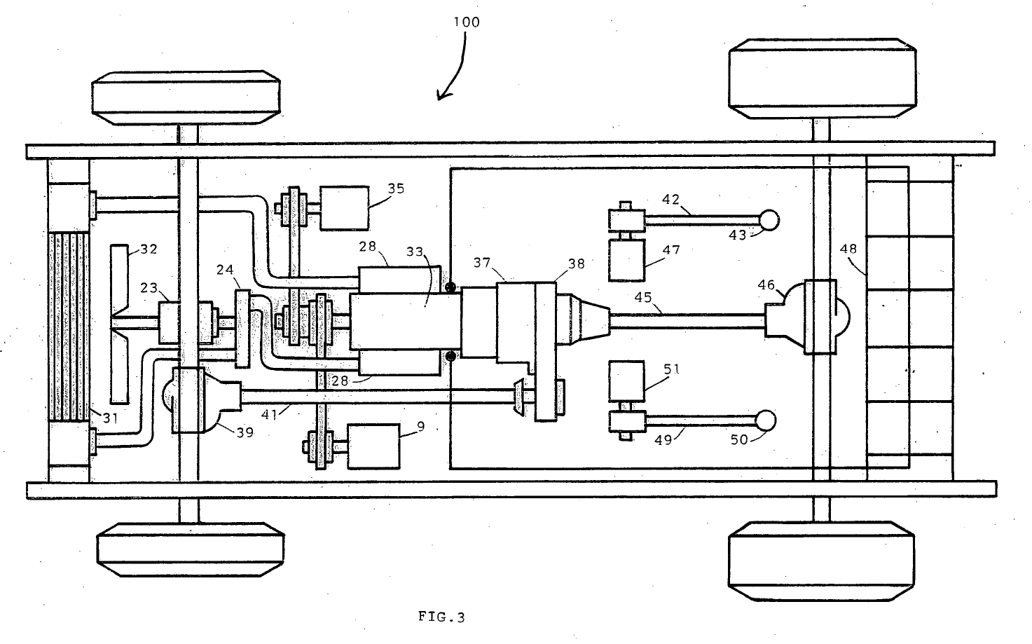

An important part of the present invention is that vehicle 100, as described in further detail below regarding FIG. 3, includes a pair of legs, each of the legs having a motor associated with the leg and having a balled foot, the legs capable of being lowered so as to make contact with the electrified track and complete an electric circuit that allows the electric track to supply electric power to drive the electric drive motor when an output from the battery pack has been turned off Thus, when the legs 42, 49 are in the “down” position the battery pack 48 is or has been switched off using battery pack switch 25.

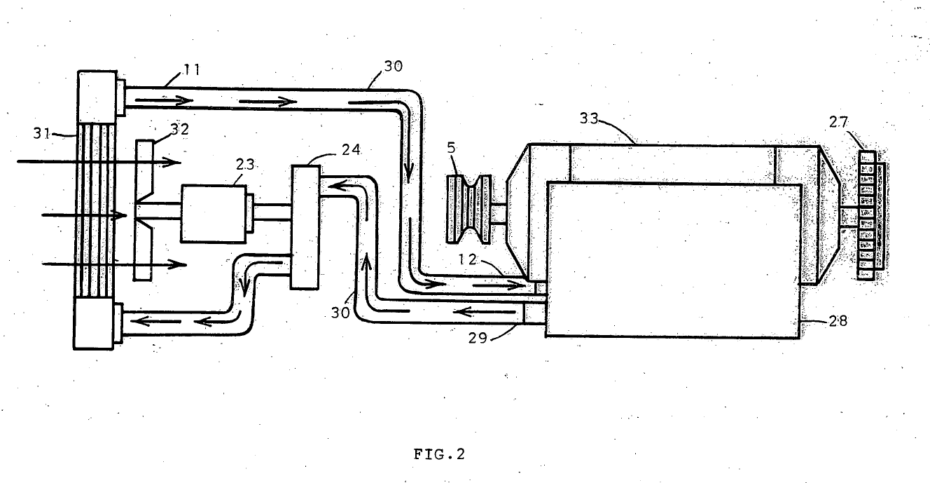

Another feature of the present invention is its cooling system for cooling the electric drive motor, which is depicted in FIG. 2. Although the cooling system is an option, a preferred embodiment would include such a system. The cooling system including a cooling tank. This is shown in FIG. 2. As seen from FIG. 2, oil pump 24 is connected fan motor 23 draws oil from the oil cooling tank 28 which surrounds the electric motor 33. Electric motor 33 is attached to a pulley 5 on one end of electric motor 33. On the other end of electric motor 33 is flywheel 27. Cooling oil flows from the oil cooling tank 28 at a first point 29 of oil piping 30 through the oil pump 24 and through the oil piping 30 to the oil radiator 31. The oil then leaves the oil radiator 31 and enters oil piping 30 at a second point 11 and then enters the oil cooling tank 28 at third point 12 of oil piping 30. This process repeats itself.

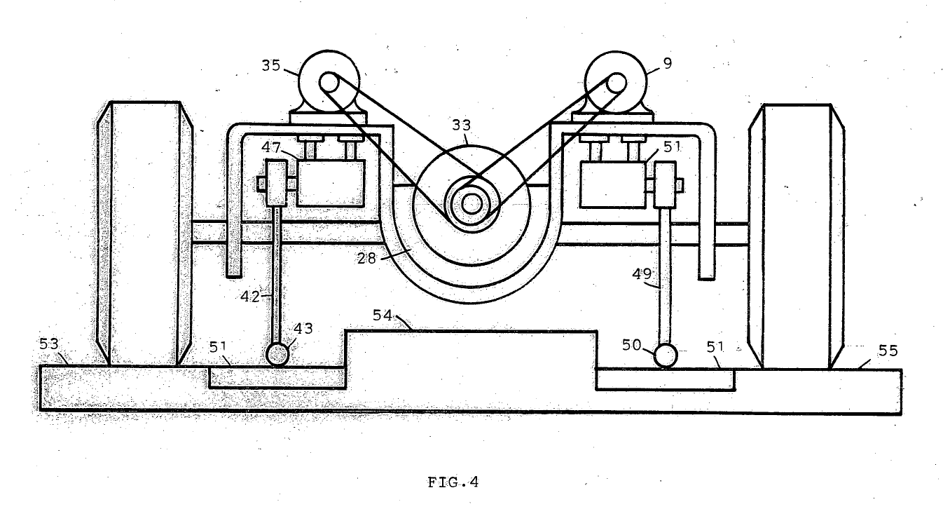

FIG. 3, which is a simple bottom view of the electric vehicle 100, shows the following parts of the vehicle: oil radiator 31, fan 32, fan motor 23, oil pump 24, auxiliary generator 35, cooling tank 28, transmission 37, transfer case 38, front differential 39, alternator 9, front drive shaft 41, first leg 42 (also called first motorized leg 42), first balled foot 43, electric drive motor 33, rear drive shaft 45, rear differential 46, first leg motor 47, battery pack 48, second motorized leg 49, second balled foot 50 and second leg motor 51. The first and second balled feet 43, 50 allow legs 42, 49 to travel along an electric track with reduced friction as the wheels of the vehicle are moving along the road. As shown in FIG. 4, the electric track 51 appears on the side of each road portion 53, 55 adjacent a road divider 54. However, the particular arrangement of the electric track and the road and divider shown in FIG. 4 is merely illustrative of one possibility and the present invention contemplates a variety of other arrangements.

Vehicle 100 also includes a portable charger for charging the batteries when the vehicle is not in use.

In a preferred embodiment, the battery pack consists of 10 batteries of which is a 12 volt battery. Preferably although not necessarily, the battery pack 48 utilizes smaller sized batteries such as the batteries used in motorcycles. The battery pack 48 can be turned on and off in the preferred embodiment by simply manually pushing a button which allows current to flow to the motor 33. The present invention does, however, contemplate other well known means for turning the battery pack on and off.

Preferably, auxiliary generator 35 produces 120 volts but in any event the auxiliary generator 35 must produce a voltage equal to the voltage provided by battery pack 48. This is because while the motor 33 can receive voltage from two different sources, the battery pack and the auxiliary generator 35, those source must be providing the same voltage. Thus, auxiliary generator 35 can assist battery pack 48 by providing extra power when battery pack 48 is turned on and when voltage regulator 21 is turned on. By manually turning on the voltage regulator 21 you are turning on the auxiliary generator to control the power coming out of the auxiliary generator. Voltage regulator 21 gets power from a single battery like the 12 volt battery one found in any car.

Although the voltage of the auxiliary generator is the same as that of the battery pack 48, the amps are different, preferably. For example, aux gen may be producing 100 amps, or auxiliary generator 33 may even be producing 185 amps like the electric drive motor which also has 185 amps, whereas the battery pack may be producing 25 amps.

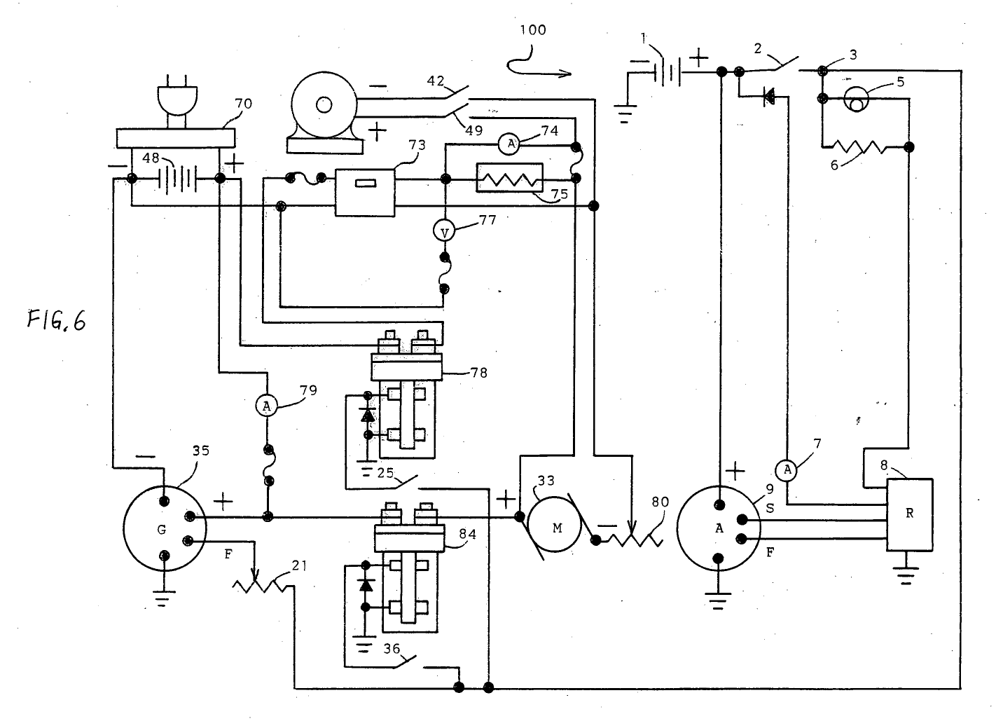

FIG. 6 shows an electrical wiring diagram for the electric vehicle of the present invention. In FIG. 6, auto battery 1 has switch 2 and accessory terminal 3 along with diode 4. Indicator light 5 advises the driver whether the alternator is operating properly or not. Resistor 6, amp meter 7 and regulator 8. Alternator 9 provides electricity for the accessory systems of the vehicle. Portable charger 70 is shown in FIG. 6 plugged into battery pack 48 in order to charge battery pack 48 whenever the vehicle 100 is not being used, for example at night, at home or when the vehicle 100 is not in use. FIG. 6 also depicts first leg motor 47 and second leg motor 51 generate electric power for and are connected to first motorized leg 42 and second motorized leg 49 respectively. Further, in FIG. 6, circuit breaker 73 amp meter 74, shunt 75 and battery pack 48 as well as voltmeter 77, battery relay 78 and amp meter 79. Auxiliary generator 35 has voltage regulator 21 and auxiliary switch 36 associated therewith. Accelerator 80 controls the amount of electric power going to motor 33. Auxiliary relay 84 and battery switch 25 are also shown in FIG. 6.

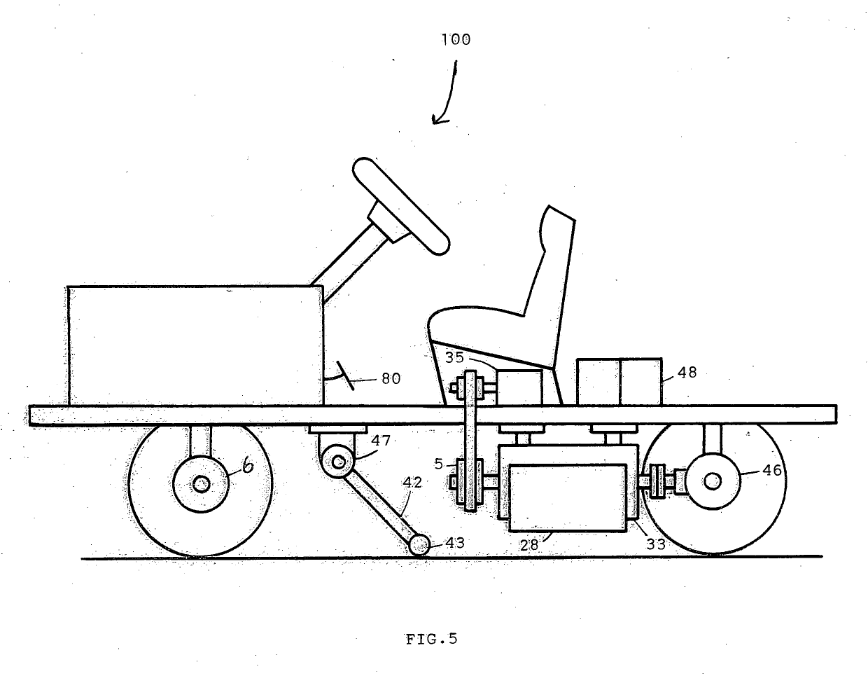

FIG. 5 is a side view of an alternative embodiment showing a rear wheel drive electric vehicle in accordance with the present invention with its motorized legs in a “down” position. In accordance with FIG. 5, accelerator 80, auxiliary generator 35, battery pack 48 and wheel assembly 6, first leg motor 47, pulley 5, first leg 42, first balled foot 43, oil cooling tank 28, electric drive motor 33 and rear wheel differential 46. In the embodiment shown in FIG. 5, vehicle 100 is based on rear wheel drive by the two rear wheels.

In the rear wheel drive version depicted in FIG. 5, the vehicle would not have a front differential 39 or a front drive shaft 41. In addition, transfer case 38 is unnecessary. Although the nature of the transmission would be different, the other components of the vehicle would be similar.

In all embodiments, vehicle 100 of the present invention is also useful for traveling through tunnels.

It is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof It is not desired to limit the invention to the exact construction and operation shown and described. The spirit and scope of this invention are limited only by the spirit and scope of the following claims.

1. An all-wheel drive electric vehicle that runs on a road and on an electrified track, comprising:
a chassis including a driving wheel,
two front wheels on opposite ends of a front axle, a front differential positioned on the front axle and a front drive shaft connected to the front differential,
two rear wheels on opposite ends of a rear axle, a rear differential positioned on the rear axle and a rear drive shaft connected to the rear differential,
a transfer case for transmitting rotary motion to the front and rear drive shafts,
an electric motor,
a battery pack and a battery switch for turning the battery pack on or off,
a transmission connected to the electric motor,
a foot powered accelerator connected to the electric motor that controls an amount of electricity that travels to the electric motor,
an alternator for generating electric power to operate accessories in the electric vehicle,
an auxiliary generator capable, once the electric vehicle attains a speed of approximately 20 m.p.h., of charging the battery pack when the battery pack has been turned off and of assisting the battery pack when the battery pack is turned on, by transmitting electricity to the electric motor for extra power,
an electrical system for conveying electrical energy from the battery pack to the electric motor and for conveying electrical energy from the auxiliary generator to the electric motor and the battery pack, the electrical system including a voltage regulator for regulating the voltage output of the auxiliary generator,
a pair of legs, each of the legs having a motor associated with the leg and having a balled foot, the legs capable of being lowered so as to make contact with the electrified track and complete an electric circuit that allows the electric track to supply electric power to drive the electric motor when an output from the battery pack has been turned off, and
a cooling system for cooling the motor, the cooling system including a cooling tank.

2. The electric vehicle of claim 1, wherein the cooling tank contains oil that is pumped and circulated through oil piping.

3. The electric vehicle of claim 1, including a portable charger for charging the batteries when the vehicle is not in use.

4. A rear wheel drive electric vehicle that runs on a road and on an electrified track, comprising:
a chassis including a driving wheel,
two front wheels on opposite ends of a front axle,
two rear wheels on opposite ends of a rear axle, a rear differential positioned on the rear axle and a rear drive shaft connected to the rear differential,
an electric motor,
a battery pack and a battery switch for turning the battery pack on or off,
a transmission connected to the electric motor,
a foot powered accelerator connected to the electric motor that controls an amount of electricity that travels to the electric motor,
an alternator for generating electric power to operate accessories in the electric vehicle,
an auxiliary generator capable, once the electric vehicle attains a speed of approximately 20 m.p.h., of charging the battery pack when the battery pack has been turned off and of assisting the battery pack when the battery pack is turned on, by transmitting electricity to the electric motor for extra power,
an electrical system for conveying electrical energy from the battery pack to the electric motor and for conveying electrical energy from the auxiliary generator to the electric motor and the battery pack, the electrical system including a voltage regulator for regulating the voltage output of the auxiliary generator,
a pair of legs, each of the legs having a motor associated with the leg and having a balled foot, the legs capable of being lowered so as to make contact with the electrified track and complete an electric circuit that allows the electric track to supply electric power to drive the electric motor when an output from the battery pack has been turned off, and
a cooling system for cooling the motor, the cooling system including a cooling tank

5. The electric vehicle of claim 4, wherein the cooling tank contains oil that is pumped and circulated through oil piping.

6. The electric vehicle of claim 4, including a portable charger for charging the batteries when the vehicle is not in use.
